(19) United States
(12) Patent Application Publication
(10) Pub. No.: US 2018/0132483 A1
(43) Pub. Date: May 17, 2018

(54) Method of Controlling Phytoparasitic Pests, Agrochemical Composition and Use Thereof

(71) Applicant: Arysta LifeScience North America, LLC, Cary, NC (US)

(72) Inventor: Alberto Albertini, San Pietro in Casale (IT)

(21) Appl. No.: 15/350,300

(22) Filed: Nov. 14, 2016

(51) Int. Cl. A01N 47/44

(52) U.S. Cl. CPC A01N 47/44

(57) ABSTRACT

A method of protecting plants against damages caused by phytoparasitic pests, such as nematodes by treating a plant, plant part, or a locus thereof with an agrochemical composition comprising an effective amount of dodine or a salt and/or a solvate thereof. An agrochemical composition for controlling phytoparasites comprising an effective amount of dodine or a salt and/or solvate thereof is also described. The agrochemical composition can be used to prevent phytoparasites, including nematodes and nematode progeny, from developing or growing and can be used to kill phytoparasites on plants, plant parts or a locus thereof.

### FIELD OF THE INVENTION

The present invention relates generally to the use of agrochemical compositions comprising dodine or a salt and/or solvate thereof to control phytoparasitic pests on plants, plant parts and locus thereof.

### BACKGROUND OF THE INVENTION

Many phytoparasitic pests, such as nematodes, are known to affect the yield, growth and health of crops and plants. Nematodes are sod-based roundworms that feed as larvae and/or adults on the root system, and other parts of the plant, resulting in physiological changes to the plant. These physiological changes in the host plant's roots can lead to the formation of galls (i.e., “knots”), which cause a disruption of the vascular system of the plant's roots, inhibiting growth. Root elongation can stop completely, resulting in inadequate supply of water and nutrients provided by the reduced root system. This in turn can cause foliage chlorosis and/or wilt, as well as stunting of growth, any of which can result in low yield or death. Root crops affected by nematodes can lose their marketability because of the non-aesthetic distortions caused by the nematode.

Since most plant-parasitic nematodes feed on plant roots, the symptoms are comparable to nutrient or water deficiency, including, yield loss, stunting, yellowing, wilting, and malformations of the root (including tubers and peanuts) caused by direct feeding damage. In addition, invasion by plant parasitic nematodes often provides an infection route for other organisms, including bacteria and fungi, since nematode activity creates an entryway into the root that would not otherwise be available, which can lead to extensive secondary decay and rotting.

Nematode reproduction is extremely fast. On average, a typical nematode life cycle may be only about 30 days or so at summer temperatures. Thus, even if nematode numbers are low at the beginning of the growing season, nematode populations can rapidly increase, becoming harmful to a crop in a relatively short period of time.

Plant-parasitic nematodes are at their most vulnerable during their active phase in soil when searching for the roots of host plants. Once they have penetrated a root, control with chemicals is more difficult as nematicidal compounds are required to be non-phytotoxic and preferably systemic.

Current treatments for controlling nematodes typically include chemicals, biologicals, and/or non-chemical methods such as systemic acquired resistance inducers to provide resistant crop strains, GMO's, and hatching stimulants and inhibitors to clear loci prior to planting. Each of these compounds and methods has one or more drawbacks, including toxicity, cost, availability, reliability, and high application amounts. New nematicidal compositions also face elevated government regulations and public scrutiny as to their environmental and ecological impacts.

While it is difficult to isolate the effect of one pest in an ecological system, the estimated overall average yearly yield loss due to nematodes is estimated at around 10-15% worldwide, with a monetary value estimated in the billions of dollars.

A list of some common soil nematicides is set forth below in Table 1. These nematicides are organized in groups, including fumigants, organophosphates and carbamates. However, the dangers associated with the manufacture and use of at least some of these nematicides has become widely known, resulting in restrictions on their use and sometimes withdrawal from the market.

TABLE 1
Common Soil Nematicides

| | | |
|---|---|---|
| Chemical name | Trade name | Formulation |

Fumigants

| | | |
|---|---|---|
| Methyl bromide | Dowfume | Gas |
| 1,3 dichloropropene | Telone/DD-95 | Liquid |
| Ethylene dibromide¹ | Dowfume W-85 | Liquid |
| Metam-sodium | Vapam | Liquid |
| Dazomet | Basamid | Dust (prill) |
| Methyl isothiocyanate | Di-Trapex | Liquid |
| Chloropicrin¹ | Larvacide | Liquid |

Organophosphates

| | | |
|---|---|---|
| Thionazin | Nemafos | Granular or emulsifiable liquid |
| Ethoprophos | Mocap | Granular or emulsifiable liquid |
| Fenamiphos | Nemacur | Granular or emulsifiable liquid |
| Fensulfothion | Dasanit | Granular |
| Terbufos | Counter | Granular |
| Isazofos | Miral | Granular or emulsifiable liquid |
| Ebufos | Rugby | Granular or emulsifiable liquid |

Carbamates

| | | |
|---|---|---|
| Aldicarb | Temik | Granular |
| Aldoxycarb | Standak | Flowable |
| Oxamyl | Vydate | Granular or emulsifiable liquid |
| Carbofuran | Furadan/Curaterr | Granular or flowable |
| Cleothocarb | Lance | Granular |

¹Use restricted.

Methyl bromide, for example, has been extensively used as a soil nematicide, although it is now heavily restricted in many countries due to its negative effect on the environment and human health. In addition, methyl bromide must also typically be applied beneath a polyethylene sheet, which cover is removed some days later and the crop is sown or planted when all traces of the fumigant have dispersed.

Other nematicides on the market, while active, are far less effective than methyl bromide, which often necessitates more applications per agricultural cycle. In addition, the target organisms can also develop resistance to the various active ingredient(s) if used continuously.

Because a product with the same performance as methyl bromide has not been developed, it is often necessary to integrate several techniques and products to achieve the same result.

Nematicides are often highly toxic compounds that have very low LD₅₀ values, which is of particular importance to operators of application machinery and other individuals at risk from exposure to the chemicals during their application. The liquid formulations of some of the non-fumigant nematicides are emulsifiable concentrates, and their use should be restricted to skilled operators who take adequate safety precautions, which may not happen in instances where basic levels of education are poor or where operators cannot read the instructions on the labels of the products.

Nematicides eventually degraded if they remain in the topsoil where there is greatest microbial activity. Once nematicides or their degradation products are flushed through the upper soil layers their persistence may be extended, resulting in toxic products in groundwater. Thus, in regions of intensive agricultural production these tolerance levels may be exceeded at certain times of the year.

Fumigants perform best in soils that do not have high levels of organic matter (which deactivates the toxicant) and that are free-draining but have adequate moisture. In general, fumigants are most effective in warm soils (12° to 15° C.) as dispersion is temperature related.

A number of organophosphate and oximecarbamate nematicides have also been developed. Many formulations of these products are granules that, when applied to the soil surface (or preferably incorporated in the top 10 cm of soil), release the active ingredient, which is spread through the soil by rainfall or irrigation. The efficacy of soil penetration depends on the amount of moisture, organic matter and soil structure. Heavy soils with relatively small pore spaces are more difficult to treat than sandy soils which have larger pore sizes. Some chemicals, particularly organophosphates, are absorbed in organic matter, in which case efficacy may be impaired.

To be effective, nematicides must persist long enough for nematodes to be exposed to lethal concentrations. At the same time, extended persistence is not desirable if there is a risk of residues in the crop or the active compounds contaminating groundwater.

Another approach for controlling nematodes involves the use of solarization (i.e., the use of the sun irradiation to heat up the soil) and is an environmentally friendly approach which is effective in the short term, but has a short persistence and low penetration into the soil. Solarization uses heat to decrease not only nematode densities, but also other harmful organisms and weed seeds and can involve pasteurization, steaming, or solarization of the soil before planting. Solarization is probably the most practical of these and generally involves covering the soil with transparent plastic sheets that allow short-wave radiation from the sun to penetrate the plastic. Once the light passes through the plastic and is reflected from the soil, the wavelength becomes longer and cannot escape through the plastic. The trapped light facilitates heating of the soil to temperatures detrimental to most living organisms.

However, cloud cover and rain can limit solar radiation and may diminish the success of solarization. In addition, soil temperatures may only rise to detrimental levels in the first 10 to 30 cm (4 to 12 inches) of soil and even in this range temperatures drop off as depth increases. Another disadvantage to solarization is that it can have a negative impact on beneficial soil organisms, since they will meet the same fate as their harmful counterparts.

A nematicide that can be safely applied to growing plants and that is translocated to the roots in sufficiently large amounts to kill endoparasitic or ectoparasistic nematodes is highly desirable to the agricultural industry.

It is also highly desirable to develop a new class of nematicides with novel activity and which are effective when used in soil, applied directly to crops or used in chemirrigation processes.

### SUMMARY OF THE INVENTION

It is an object of the present invention to provide an agrochemical composition effective against phytoparasitic pests.

It is another object of the present invention to provide an agrochemical composition that is effective against nematodes and their progeny.

It is still another object of the present invention to provide an improved agrochemical composition that is effective against nematodes and that can be used via chemirrigation.

It is still another object of the present invention to provide an agrochemical composition that is effective against phytoparasitic pests and that uses dodine or a salt and/or solvate thereof as an effective nematicide.

It is still another object of the present invention to develop a new class of nematicides with novel activity and which are highly effective when used in soil, applied directly to crops and used in chemirrigation processes.

It is yet another object of the present invention to provide an improved nematicide composition with good pest resistance.

To that end, in one embodiment, the present invention relates generally to a method of protecting plants against damages caused by phytoparasitic pests, the method comprising treating a plant, plant part, or a locus thereof with an agrochemical composition comprising an effective amount of dodine or a salt and/or a solvate thereof.

In another preferred embodiment, the present invention relates generally to a method for controlling phytoparasitic pests at a locus, the method comprising: applying to the locus an agrochemical composition comprising an effective amount of dodine or a salt and/or a solvate thereof.

In another preferred embodiment, the present invention relates generally to an agrochemical composition for controlling nematodes, the agrochemical composition comprising:

a) dodine, wherein the dodine is present in the agrochemical composition in an effect amount to control nematodes or nematode progeny when applied to plant, plant part or a locus thereof;

b) one or more auxiliaries selected from the group consisting of solvents, surfactants, stabilizers, anti-foaming agents, anti-freezing agents, preservatives, antioxidants, colorants, thickeners and inert fillers; and

c) optionally, an additional active ingredient selected from the group consisting of bactericides, fungicides, insecticides, nematicides, molluscicides, herbicides, and combinations of one or more of the foregoing.

### DETAILED DESCRIPTION OF THE PREFERRED EMBODIMENTS

The present invention relate generally to the use of dodine or a salt and/or solvate thereof in agrochemical compositions and formulations that are effective against soil nematodes.

As used to in the present disclosure and claims, the term “nematodes” encompass all species of the order Nematoda and in particular species that are parasitic or cause health problems to plants (including, for example, species of the orders Aphelenchida, Tylenchida and others) or to humans and animals (for example species of the orders Ascaradida, Oxyurida, Strongylida, Stronglyloides and Trichocephalida). As referred to in the present disclosure and claims a “parasitic nematodes” are nematodes that injure or damage tissue or cause other forms of disease in plants.

Plant nematodes encompass plant parasitic nematodes and nematodes living in the soil. Plant parasitic nematodes include, but are not limited to, ectoparasites such as Xiphinema spp., Longidorus spp., and Trichodorus spp.; semiparasites such as Tylenchulus spp.; migratory endoparasites such as Pratylenchus spp., Radopholus spp., and Scutellonerna. spp.; sedentary parasites such as Heterodera spp., Globodera spp., and Meloidogyne spp., and stem and leaf endoparasites such as Ditylenchus spp., Aphelenchoides spp., and Hirshmaniella spp. The compounds described herein are distinguished especially for their effective control of harmful root parasitic soil nematodes such as, cyst-forming nematodes of the genera Heterodera or Globodera, and/or root knot nematodes of the genus Meloidogyne. Harmful species of these genera are for example Meloidogyne incognata, Heterodera glycines (soybean cyst nematode), Globodera pallida and Globodera rostochiensis (potato cyst nematode), which species are effectively controlled with the compounds described herein. However, the use of the compounds described herein is in no way restricted to these genera or species, but also extends in the same manner to other nematodes.

As used herein, the term “nematicide” refers to a compound used to control (including prevention, reduction or elimination) parasitic nematodes. “Controlling nematodes” as used in the present invention means killing nematodes or preventing nematodes to develop or to grow. Controlling nematodes as used herein also encompasses controlling nematode progeny (development of viable cysts and/or egg masses). The compounds described herein, may be used to keep an organism healthy and may be used curatively, preventively or systematically to control nematodes.

“Organism” as described herein, may refer to a plant. When using the compounds described herein to keep a plant healthy, the controlling of nematodes as used herein includes the reduction of damage to plants and increased yield. Alternatively, the organism may be a human or an animal. When using the compounds described herein to keep a human or animal healthy, the use encompasses therapeutic use and veterinarian use with the aim to prevent or to cure damage by nematodes.

As used herein, the term “infestation” refers to the presence of nematodes in numbers that pose a risk to plants. The presence can be in the environment, e.g., on an agricultural crop or other type of plant.

As used herein, the terms “parasiticidal” and “parasiticidally” refers to observable effects on a parasitic nematode to provide protection of a plant from the nematode. Parasiticidal effects typically relate to diminishing the occurrence or activity of the target parasitic nematode. Such effects on the nematode include necrosis, death, retarded growth, diminished mobility or lessened ability to remain on or in the host plant, reduced feeding and inhibition of reproduction. These effects on parasitic nematodes provide control (including prevention, reduction or elimination) of parasitic infestation of the plant. Therefore the term “control” of a parasitic nematode means achieving a parasiticidal effect on the nematode. The expressions “parasiticidally effective amount” and “biologically effective amount” in the context of applying a chemical compound to control a parasitic nematode refer an amount of the compound that is sufficient to control the parasitic nematode.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, the term “immediately,” including “immediately before” or “immediately after” refers to a time period that is within one day, more preferably within several hours, more preferably within one hour, and still more preferably within several minutes.

In one embodiment, the present invention relates generally to a method of protecting plants against damages caused by phytoparasitic pests, the method comprising treating a plant, plant part, or a locus thereof with an agrochemical composition comprising an effective amount of dodine or a salt and/or a solvate thereof.

While certain forms of dodine are known for use as a fungicide, the use of dodine as a nematicide against phytoparasitic nematodes has not previously been contemplated.

Various forms of dodine may be used in the agrochemical composition described herein, including salts and/or solvates of dodine. For example, one form of dodine is available under the tradename Syllit and has been used as a foliar fungicide and bactericide. Its efficacy as a soil nematicide was discovered after carrying out laboratory and indoor trials. In one embodiment, the dodine used in the agrochemical composition is an acetate form of dodine, such as 1-dodecylguanidinium acetate (dodecylguanidine monoacetate), which has a molecular formula C₁₅H₃₃N₃O₂. Other forms of dodine, such as dodine HCl 35% would also be usable in compositions of the present invention.

In one embodiment, dodine can be used via chemirrigation and its efficacy can fit with the need to have available a product with a way of action and chemical structure that are different form existing nematicides, in order to manage parasitic nematodes in soil. The inventors of the present invention have also found that dodine is active against soil Fusarium sp.

The agrochemical compositions of the present invention may further contain one or more agriculturally acceptable auxiliaries. The auxiliaries employed in the agrochemical composition and their amounts will depend in part upon the type of formulation or composition and/or the manner in which the formulation is to be applied. Suitable auxiliaries include, but are not limited to formulation adjuvant or components, such as solvents, surfactants, stabilizers, anti-foaming agents, anti-freezing agents, preservatives, antioxidants, colorants, thickeners and inert fillers and these auxiliaries may be used individually in the agrochemical composition or as a combination of one or more auxiliaries.

For example, the composition may comprise one or more solvents, which may be organic or inorganic. Suitable solvents are those that thoroughly dissolve the agrochemically active substances employed. Examples of suitable solvents include water, aromatic solvents, such as xylene (for example solvent products commercially available from Solvesso™), mineral oils, animal oils, vegetable oils, alcohols, for example methanol, butanol, pentanol, and benzyl alcohol; ketones, for example cyclohexanone, and gamma-butyrolactone, pyrrolidones, such as NMP, and NOP, acetates, such as glycol diacetate, glycols, fatty acid dimethylamides, fatty acids, and fatty acid esters.

The composition may optionally include one or more surfactants. Suitable surfactants are generally known in the art and include, but are not limited to, alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, arylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose and ethylene oxide/propylene oxide block copolymers.

The composition may optionally comprise one or more polymeric stabilizers. Suitable polymeric stabilizers that may be used in the present invention include, but are not limited to, polypropylene, polyisobutylene, polyisoprene, copolymers of monoolefins and diolefins, polyacrylates, polystyrene, polyvinyl acetate, polyurethanes or polyamides.

The composition may include an anti-foaming agent. Suitable anti-foam agents include, for example, mixtures of polydimethylsiloxanes and perfluroalkylphosphonic acids, such as the silicone anti-foam agents.

One or more preservatives may also be present in the composition. Suitable examples include, for example, Preventol® (commercially available from Bayer AG) and Proxel® (commercially available from Bayer AG).

Furthermore, the composition may also include one or more antioxidants, such as butylated hydroxytoluene.

The compositions may further comprise one or more solid adherents. Such adherents are known in the art and available commercially. They include organic adhesives, including tackifiers, such as celluloses of substituted celluloses, natural and synthetic polymers in the form of powders, granules, or lattices, and inorganic adhesives such as gypsum, silica, or cement.

The compositions may include one or more inert fillers, including, for example, natural ground minerals, such as kaolins, aluminas, talc, chalk, quartz, attapulgite, montmorillonite, and diatomaceous earth, or synthetic ground minerals, such as highly dispersed silicic acid, aluminum oxide, silicates, and calcium phosphates and calcium hydrogen phosphates. Suitable inert fillers for granules include, for example, crushed and fractionated natural minerals, such as calcite, marble, pumice, sepiolite, and dolomite, or synthetic granules of inorganic and organic ground materials, as well as granules of organic material, such as sawdust, coconut husks, corn cobs, and tobacco stalks.

The compositions may also include one or more thickeners, including, for example, gums, such as xanthan gum, PVOH, cellulose and its derivatives, clay hydrated silicates, magnesium aluminum silicates or a mixture thereof.

In some embodiments of the present invention, the agrochemical composition may be applied and used in pure form, or more preferably together with at least one of the auxiliaries, as described above.

The composition of the present invention may also comprise other active ingredients for achieving specific effects, for example, bactericides, fungicides, insecticides, nematicides, molluscicides or herbicides. Suitable compounds are known in the art.

The agrochemical composition of the present invention may be formulated in different ways, depending upon the circumstances of its use. Suitable formulation techniques are known in the art and include water-dispersible powders, dusts, pastes, water-dispersible granules, solutions, emulsifiable concentrates, emulsions, suspension concentrates, aerosols, or microencapsulation suspensions.

Examples of formulation types for use in the present invention include the following:

A) Water-soluble concentrates, in which dodine or a salt and/or solvate thereof is dissolved in a water-soluble solvent. One or more wetting agents and/or other auxiliaries may be included. The active compound dissolves upon dilution with water.

B) Emulsifiable concentrates, in which dodine or a salt and/or solvate thereof is dissolved in a water-immiscible solvent, preferably with the addition of one or more non-anionic emulsifiers and anionic emulsifiers. The mixture is agitated, for example by stirring, to get a uniform formulation. Dilution with water provides a stable emulsion.

C) Emulsions, in which dodine or a salt and/or solvate thereof is dissolved in one or more suitable water immiscible solvents, preferably with the addition of one or more non-anionic emulsifiers and anionic emulsifiers. The resulting mixture is introduced into water by appropriate means, such as an emulsifying machine, to provide a homogeneous emulsion. Dilution with water gives a stable emulsion.

D) Suspensions, in which dodine or a salt and/or solvate thereof is comminuted in an agitated ball mill, preferably with the addition of one or more dispersants and wetting agents, and water or solvent to give a fine active compound suspension. Dilution with water gives a stable suspension of the active compound.

E) Water-dispersible granules and/or water-soluble granules in which dodine or a salt and/or solvate thereof is ground finely, preferably with the addition of one or more dispersants and wetting agents, and prepared as water-dispersible or water-soluble granules by means of suitable techniques, for example by extrusion, drying in a spray tower, or by processing in a fluidized bed. Dilution with water gives a stable dispersion or solution of the active compound.

F) Water-dispersible powders and water-soluble powders, in which dodine or a salt and/or solvate thereof is ground in a suitable apparatus, such as a rotor-stator mill, preferably with addition of one or more dispersants, wetting agents and silica gel. Dilution with water gives a stable dispersion or solution of the active compound.

G) Granules, in which dodine or a salt and/or solvate thereof is finely ground in a suitable apparatus, with addition of up to 99.5 parts by weight of carriers. Granules can then be prepared either by suitable techniques, such as extrusion, spray-drying or using a fluidized bed.

In one embodiment, the present invention describes the use of the agrochemical composition or formulation described herein for the control of pests at a locus, in particular for use as a nematicide.

In a still further aspect, the present invention provides a method for controlling pests, in particular nematodes, at a locus, comprising applying to the locus an agrochemical composition or formulation as described herein.

In use, the composition of the present invention may be applied to the target plant or plant of interest, to one or more parts thereof (such as leaves or seeds or roots), or to the locus thereof.

In another embodiment, the present invention provides a method of controlling nematodes and other plant pests and pathogens at a locus, comprising applying to the locus an agrochemical composition or formulation comprising an effective amount of dodine.

The composition and method of the present invention find particular advantageous use in the control of nematodes in crops. Suitable target crops include, for example, cereals, including wheat, barley, rye, oats, rice, maize, sorghum, millet and manioc; beets, including sugar beets and fodder beets; fruits, including pomes, stone fruit and soft fruit, such as apples, pears, plums, peaches, almonds, cherries, or berries, for example strawberries, raspberries and blackberries; leguminous plants, including beans, lentils, peas and soybeans; oil plants, including rape, mustard, poppy, olives, sunflowers, coconut, castor oil plants, cocoa beans and groundnuts; cucurbitaceae, including marrows, cucumbers and melons; fibrous plants, including cotton, flax, hemp and jute; citrus fruit, including oranges, lemons, grapefruit and mandarins; vegetables, including spinach, lettuce, asparagus, cabbages, carrots, onions, tomatoes, potatoes and paprika; lauraceae, including avocados, cinnamon and camphor; as well as tobacco, nuts, coffee, aubergines, sugar cane, tea, pepper, vines, hops, bananas, natural rubber plants, eucalyptus, and ornamental plants. Examples of some preferred crops for treatment include, for example, tomatoes, peppers, cucumbers, melons, coffee and soybeans.

The agrochemical compositions described herein can be used to protect vegetables, especially tomatoes, eggplant, peppers, cucurbits, etc., floral and ornamental crops and the nursery of top fruit, vegetables, ornamentals and floral crops, in open fields, under glasshouse or greenhouse or in tunnel.

In general, the composition or formulation is prepared and applied such that the agrochemical composition comprising dodine or a salt and/or solvate thereof is applied at any suitable rate, as demanded by the locus to be treated. The application rate may vary within wide ranges and depends upon such factors as the soil constitution, the type of application (i.e., foliar application, seed dressing, application in the seed furrow, etc.), the target crop plant, the particular nematode(s) to be controlled, the climatic circumstances prevailing in each case, as well as other factors determined by the type of application, timing of application and target crop. Typically, the application rate may be from about 1 to about 5,000 g (or ml) of the agrochemical composition per hectare, and depending on the various factors described above, may be 10 to 4,000 g/ha, more preferably 100 to 3,500 g/ha, more preferably 1,000 to 3,000 g/ha. In many, but not all, crops the composition is applied as an in-furrow application where about 20% to about 50% of the soil surface is treated with the application rate.

According to the present invention, the use of the agrochemical composition or formulation comprising dodine or a salt and/or solvate thereof may be applied at any suitable time. In some embodiments, the composition is applied to the soil or the locus of the plant prior to planting, during planting, or after planting. Such a treatment may take place by conventional methods known in the art, including, for example, drip-irrigation, chem-irrigation, spray, and soil fumigation. In some embodiments, the active compounds are applied to the plant propagation material, such as a seed, by seed coating. In one embodiment, the agrochemical composition is contacted with the plant, plant part, or a locus thereof immediately before or immediately after the plant is transplanted.

The step of treating the plant, plant part or a locus thereof may also be repeated one or more times at a fixed interval. The fixed interval may be between 1 and 40 days, preferably between 7 and 40 days and most preferably between 14 and 30 days. Thus, the fixed interval may be, for example, 7 days, 10 days, 14 days, 21 days, 30 days, etc. depending on various factors, including the infestation of phytoparasites in the plants, plant parts or locus thereof, the application method of the agrochemical composition and the strength (i.e., concentration of dodine in the agrochemical composition.

According to the present invention, the use of the agrochemical composition or formulation comprising dodine or a salt and/or solvate thereof for treating plants, plant parts, or a locus thereof is through the use of various processing methods carried out directly on the plant or plant parts or to the environment, the habitat or storage space of the plant or plant parts. These methods include, for example, dipping, spraying, atomizing, irrigation, evaporation, powdering, misting, fogging, spreading, foam, coating, painting, spreading-on, watering, soaking, drip irrigation, and chemirrigation. In addition, by using an ultra-low volume method, the agrochemical composition or formulation comprising dodine can be applied or incorporated or mixed directly into the soil to proactively treat the soil and prevent phytoparasites, including nematodes and nematode progeny, from developing or growing.

Thus, in one embodiment, the present invention describes methods for nematode population control comprising the steps of contacting the seeds with an aqueous composition comprising dodine or a salt and/or solvate thereof and an optional component selected from one or more pesticides and/or one or more natural plant hormones. The seeds may be contacted with the composition by various means including spraying, rolling, or tumbling in a continuous or batch-treating process. The agrochemical composition or formulation comprising dodine can be mixed in aqueous media at a concentration, and brought into contact with the seeds for a time sufficient to provide for nematode population control in the intended locus of planting.

For seed treatment applications, a concentrate composition can be diluted up to about 600-fold or more with water, more typically up to about 100-fold or up to about 40-fold. Illustratively, a concentrate product can be applied at about 0.01 mg/Kg seed to about 10 mg/Kg seed, for example about 0.1 mg/Kg seed, 0.5 mg/Kg seed, 2.5 mg/Kg seed or a higher amount. Other concentrations of the compositions disclosed herein can be used.

Application solutions prepared by using (or diluting) concentrate compositions as described above represent further aspects of the compositions and methods disclosed and described herein. For example, the agrochemical composition comprising the effective amount of dodine or a salt and/or solvate thereof may be combined with water and distributed through soil irrigation systems that allow a user to control the amount of and ratio of water and the agrochemical composition, including in drip irrigation, for use in combination with liquid fertilizer applications, or for local distribution by watering can.

In one embodiment the agrochemical composition is prepared as a suspension concentrate in which the suspension concentrate comprises about 400 g/l to about 700 g/l dodine, more preferably about 500 to about 600 g/l dodine, and most preferably about 525 g/l to about 575 g/l dodine. In one embodiment, the suspension concentrate may contain 540 g/l or 542 g/l or 544 g/l or 546 g/l or 548 g/l or 550 g/l dodine. One particularly preferred composition comprises 35% by weight dodecyl guanidine hydrochloride, 15% by weight isopropanol, and 50% by weight water. Other suitable compositions would also be usable in the practice of the invention.

In another embodiment, the agrochemical composition is prepared as a water soluble granule, in which the dodine or a salt and/or solvate thereof is present in the water soluble granule in an amount of between about 30 to about 80 percent by weight, more preferably between about 40 and about 70 percent by weight and most preferably between about 60 and about 65 percent by weight.

For application to plant foliage, the agrochemical composition can be diluted up to about 600-fold or more with water, more typically up to about 100-fold or up to about 40-fold. Illustratively, a concentrate product can be applied at about 0.1 to about 30 liter/hectare (l/ha), for example about 5 to about 25 l/ha, in a total application volume after dilution of about 60 to about 600 l/ha, for example about 80 to about 400 l/ha or about 100 to about 200 l/ha Other concentrations of the concentrate compositions disclosed herein can be used.

The agrochemical compositions disclosed herein can be applied in a sequential order, for example, the seeds, plant, or (and then) its locus can be contacted with the dodine or a salt and/or solvate thereof, and optionally at least one pesticide and the post-emergent plant or its locus can be contacted with the dodine and optionally at least one pesticide. The frequency of an application and rate of the compositions disclosed and described herein can be varied depending on many factors.

It may also be advantageous to apply a relatively high “starter” rate, followed by one or more subsequent applications at a lower rate. Application frequency can be, for example, a single application up to three applications per season. In certain situations, a single application will suffice. In other situations, the first and/or second and/or third application may precede, supersede, or correspond to a particular growth cycle of the plant, or a known life cycle or endemic habit of the nematode.

The following Examples illustrate embodiments of the disclosure.

These Examples are intended to be illustrative only and are not intended to limit the scope of the disclosure. Also, parts and percentages are by weight unless otherwise indicated. As used herein, “room temperature” refers to a temperature of from about 20° C. to about 25° C.

### EXAMPLES

A pot trial was conducted against root-knot nematodes on greenhouse tomatoes. The experiments were conducted in the south of Italy.

Crop: Tomatoes

Nematode inoculation: 15 individuals/ml soil

TABLE 2
Application Time Interval:

| Application | Time elapse (Days) |
|---|---|
| A | 0 |
| B | 7 |
| C | 34 |

Drench volume: 6000 l/ha

TABLE 3
Drench volume

| Percentage | Liters/hectare | Liters/pot | Method of application |
|---|---|---|---|
| 50.0 | 9000 | 0.3 | Initial water |
| 33.3 | 6000 | 0.2 | Chemirrigation |
| 16.7 | 3000 | 0.1 | Final water |

A suspension concentrate was prepared comprising 544 g/l 1-dodecylguanidinium acetate in water as set forth below in Table 4. As indicated in Table 4, Example 1 is a control, which consists of water; Examples 2-6 set forth various dosages of the suspension concentrate. Example 7 is a comparative example using the nematicide Devguard 500SC, a suspension concentrate containing 500 g/l iprodione (available from DEVGEN NV). Example 8 is a comparative examples using the nematicide Vydate 10L, a water soluble liquid containing 10% oxamyl (available from DuPont). The dosage, number of applications, timing of the applications and application code (which corresponds to the plot map) are also set forth in Table 4.

TABLE 4
Dosage amount and timing

| Example | | Dosage | Appl. | Appl. | Appl. |
|---|---|---|---|---|---|
| No. | Product | (liter/ha) | No. | Timing | Code |
| 1 | Untreated check | — | 3 | 0-7-34-DAT | ABC |
| | (water) | | | | |
| 2 | Suspension concentrate | 3.50 | 3 | 0-7-34-DAT | ABC |
| 3 | Suspension concentrate | 2.63 | 3 | 0-7-34-DAT | ABC |
| 4 | Suspension concentrate | 1.75 | 3 | 0-7-34-DAT | ABC |
| 5 | Suspension concentrate | 1.17 | 3 | 0-7-34-DAT | ABC |
| 6 | Suspension concentrate | 0.88 | 3 | 0-7-34-DAT | ABC |
| 7 | Devguard 500SC | 2.00 | 3 | 0-7-34-DAT | ABC |
| 8 | Vydate 10L | 20 + 10 + 10 | 3 | 0-7-34-DAT | ABC |

The plants were assessed at day 41 for plant vigor during initial growth, including height, biomass, phenology, soil nematode population (specimens/ml soil) and roots nematode population (specimens/g root). The plant weight, height and vigor index as measured on a sample of three plants per plot were then calculated and the results are tabulated in Table 5.

TABLE 5
Summary of Results

| | | | | | Plant | | |
|---|---|---|---|---|---|---|---|
| Ex. | | Plant Wt. | Plant Wt._{Ave.} | Plant height | height_{Ave.} | Vigor index | Vigor index_{Ave.} |
| No. | Plot | (g) | (g) | (cm) | (cm) | (g/cm) | (g/cm) |
| 1 | A | 42.7 | 45.8 | 50.7 | 54.3 | 0.85 | 0.85 |
| | B | 42.4 | | 54.0 | | 0.79 | |
| | C | 54.4 | | 54.7 | | 1.00 | |
| | D | 43.8 | | 58.0 | | 0.76 | |
| 2 | A | 44.6 | 48.5 | 55.7 | 59.2 | 0.80 | 0.82 |
| | B | 53.0 | | 63.7 | | 0.84 | |
| | C | 48.3 | | 59.7 | | 0.81 | |
| | D | 47.9 | | 57.7 | | 0.83 | |
| 3 | A | 36.5 | 43.2 | 46.3 | 53.8 | 0.79 | 0.80 |
| | B | 43.1 | | 56.3 | | 0.77 | |
| | C | 50.0 | | 55.3 | | 0.90 | |
| | D | 43.1 | | 57.0 | | 0.75 | |
| 4 | A | 38.4 | 40.4 | 56.3 | 59.8 | 0.68 | 0.68 |
| | B | 38.2 | | 56.3 | | 0.68 | |
| | C | 42.7 | | 59.3 | | 0.72 | |
| | D | 42.3 | | 67.3 | | 0.63 | |
| 5 | A | 52.2 | 47.0 | 53.7 | 53.8 | 0.99 | 0.89 |
| | B | 45.1 | | 56.0 | | 0.82 | |
| | C | 42.9 | | 48.3 | | 0.90 | |
| | D | 47.8 | | 57.0 | | 0.85 | |
| 6 | A | 39.6 | 43.2 | 51.7 | 55.4 | 0.77 | 0.78 |
| | B | 47.8 | | 58.0 | | 0.82 | |
| | C | 42.6 | | 56.3 | | 0.76 | |
| | D | 42.9 | | 55.7 | | 0.77 | |
| 7 | A | 55.2 | 54.4 | 50.3 | 51.2 | 1.10 | 1.08 |
| | B | 50.3 | | 52.7 | | 0.95 | |
| | C | 56.8 | | 55.0 | | 1.04 | |
| | D | 55.5 | | 46.7 | | 1.22 | |
| 8 | A | 41.6 | 45.9 | 52.0 | 57.8 | 0.80 | 0.80 |
| | B | 52.0 | | 66.0 | | 0.79 | |
| | C | 41.1 | | 53.0 | | 0.78 | |
| | D | 48.8 | | 60.0 | | 0.81 | |

As can be seen from the results set forth in Table 5, the compositions containing dodine performed in a similar manner and produced a similar result to the compositions containing either Devguard 500SC or Vydate 10L as the nematicide, thus demonstrating that dodine can be used as an effective nematicide.

The first assessment showed very good results for the higher application rate of dodine (Example 2), which was better than the result achieved by Devguard 500SC and not quite as good as the results achieved by Vydate 10L. The difference between the compositions of the invention containing dodine and Vydate 10L were very narrow and related to the few galls that developed on an old root in one of the plants treated with the dodine composition. However, all of the new roots were healthy and well developed.

Finally, it should also be understood that the following claims are intended to cover all of the generic and specific features of the invention described herein and all statements of the scope of the invention that as a matter of language might fall there between.

1. A method of protecting plants against damages caused by phytoparasitic pests, the method comprising treating a plant, plant part, or a locus thereof with an agrochemical composition comprising an effective amount of dodine or a salt and/or a solvate thereof, wherein the effective amount is an amount that is sufficient to prevent the phytoparasitic pests from growing or developing on the plant, plant part or locus thereof or an amount that is sufficient to kill the phytoparasitic pests on the plant, plant part, or locus thereof.

2. The method according to claim 1, wherein the agrochemical composition is an aqueous composition.

3. The method according to claim 1, wherein the dodine comprises 1-dodecylguanidinium acetate.

4. (canceled)

5. (canceled)

6. The method according to claim 1, wherein the agrochemical composition comprises one or more auxiliaries selected from the group consisting of solvents, surfactants, stabilizers, anti-foaming agents, anti-freezing agents, preservatives, antioxidants, colorants, thickeners and inert fillers.

7. The method according to claim 6, wherein the one or more auxiliaries comprises a solvent.

8. The method according to claim 1, wherein the phytoparasitic pest comprises nematodes or nematode progeny.

9. The method according claim 1, wherein the application to the plant to be treated or to the locus thereof also controls fungi.

10. The method according to claim 1, wherein said locus is soil.

11. The method according to claim 1, wherein the agrochemical composition further comprises an additional active ingredient selected from the group consisting of bactericides, fungicides, insecticides, nematicides, molluscicides, herbicides, and combinations of one or more of the foregoing.

12. The method according to claim 1, wherein the agrochemical composition is formulated as a water-soluble concentrate, an emulsifiable concentrate, an emulsion, a suspension, a water-dispersible or water-soluble granule, a water-dispersible a water soluble powder, or a granule.

13. The method according to claim 12, wherein the agrochemical composition is formulated as a suspension concentrate, said suspension concentrate containing about 400 to about 700 g/l dodine, water and an alcohol.

14. The method according to claim 1, wherein the agrochemical composition is contacted with the plant, plant part, or a locus thereof immediately before or immediately after the plant is transplanted.

15. The method according to claim 1, wherein the step of treating the plant, plant part or a locus thereof is repeated one or more times at a fixed interval.

16. The method according to claim 15, wherein the fixed interval is between 1 and 40 days.

17. A method for controlling phytoparasitic pests in soil, the method comprising:
applying to the soil an agrochemical composition comprising an effective amount of dodine or a salt and/or a solvate thereof, wherein the effective amount is an amount that is sufficient to prevent the phytoparasitic pests from growing or developing in the soil or an amount that is sufficient to kill the phytoparasitic pests in the soil.

18. (canceled)

19. (canceled)

20. (canceled)

21. The method according to claim 17, wherein the dodine comprises 1-dodecylguanidinium acetate.

22. The method according to claim 17, wherein the agrochemical composition comprises one or more auxiliaries selected from the group consisting of solvents, surfactants, stabilizers, anti-foaming agents, anti-freezing agents, preservatives, antioxidants, colorants, thickeners and inert fillers.

23. The method according to claim 22, wherein the one or more auxiliaries comprises a solvent.

24. The method according to claim 17, wherein the phytoparasitic pest comprises nematodes or nematode progeny.

25. The method according to claim 17, wherein the agrochemical composition further comprises an additional active ingredient selected from the group consisting of bactericides, fungicides, insecticides, nematicides, molluscicides, herbicides, and combinations of one or more of the foregoing.

26. The method according to claim 17, wherein the agrochemical composition is formulated as a water-soluble concentrate, an emulsifiable concentrate, an emulsion, a suspension, a water-dispersible or water-soluble granule, a water-dispersible a water soluble powder, or a granule.

27. (canceled)

28. (canceled)

29. (canceled)

30. The method according to claim 17, wherein the step of applying the agrochemical composition to the soil is by means of chemirrigation.

31. The method according to claim 1, wherein the agrochemical composition comprises one or more solvents, the one or more solvents comprising water and an alcohol.

32. The method according to claim 17, wherein the agrochemical composition is applied as an in-furrow application, wherein about 20% to about 50% of the soil surface is treated with the agrochemical composition.

33. The method according to claim 17, comprising the step of incorporating the agrochemical composition directly into the soil, wherein the soil is treated to prevent phytoparasitic pests from developing or growing.

34. The method according to claim 17, wherein the agrochemical composition consists of 400 to 700 g/L of dodine in water.
